(19) United States
(12) Patent Application Publication
(10) Pub. No.: US 2026/0106178 A1
(43) Pub. Date: Apr. 16, 2026

(54) FUEL ELECTRODE LAYER AND ELECTROCHEMICAL CELL

(71) Applicant: DENSO CORPORATION, Kariya-city (JP)

(72) Inventors: Atsuhiro SUMIYA, Kariya-city (JP); Takuma HITOMI, Kariya-city (JP); Tetsuro SERAI, Nisshin-city (JP)

(73) Assignee: DENSO CORPORATION, Kariya-city (JP)

(21) Appl. No.: 19/354,450

(22) Filed: Oct. 9, 2025

(30) Foreign Application Priority Data
Oct. 11, 2024 (JP) 2024-178709

(51) Int. Cl. H01M 4/86; C25B 9/19; C25B 11/037; C25B 11/047; C25B 13/07; H01M 4/90; H01M 8/12; H01M 8/126

(52) U.S. Cl. CPC H01M 4/8663; C25B 9/19; C25B 11/037; C25B 11/047; C25B 13/07; H01M 4/9025; H01M 8/126; H01M 2008/1293

(57) ABSTRACT

A fuel electrode layer of the present disclosure is used in a solid oxide-type electrochemical cell. The fuel electrode layer has catalyst material particles, solid electrolyte particles, and at least one metal M selected from a group consisting of metals having a standard electrode potential more negative than that of Ni. The catalyst material particle includes Ni as its primary component, and further includes the metal M. The solid electrolyte particle includes a ceria-based oxide as its primary component, and further includes the metal M. A solid oxide-type electrochemical cell of the present disclosure has the fuel electrode layer described above, a solid electrolyte layer, and an air electrode layer, which is formed as a counter electrode to the fuel electrode layer, in this order.

### CROSS-REFERENCE TO RELATED APPLICATION

This application is based on and claims the benefit of priority from earlier Japanese Patent Application No. 2024-178709, filed in Japan on Oct. 11, 2024, the description of which is hereby incorporated by reference.

### BACKGROUND

### 1. Technical Field

The present disclosure relates to a fuel electrode layer and an electrochemical cell.

### 2. Related Art

Some conventional electrochemical cells use solid oxide as an electrolyte. Solid oxide electrolysis cells (hereinafter referred to as “SOEC”) and solid oxide fuel cells (hereinafter referred to as “SOFC”) are specific examples of solid oxide-type electrochemical cells. SOECs can synthesize hydrogen or hydrocarbons. Therefore, SOECs are useful for realizing a circular carbon economy. On the other hand, SOFCs can generate electricity from fuels such as hydrogen, demonstrating excellent efficiency compared to other fuel cells. Therefore, SOFCs are effective for energy conservation and low-carbonization. The solid oxide-type electrochemical cells can also be reversibly operated as both SOECs and SOFCs in the same configuration, depending on materials.

A fuel electrode layer used in this type of electrochemical cells is generally formed by a composite material containing Ni particles, which are catalyst material particles, and yttria-stabilized zirconia (hereinafter referred to as “YSZ”), which are solid electrolyte particles.

### SUMMARY

The present disclosure provides a fuel electrode layer and a solid oxide-type electrochemical cell.

A first aspect of the present disclosure provides a fuel electrode layer for use in a solid oxide-type electrochemical cell. The fuel electrode layer has catalyst material particles, solid electrolyte particles, and at least one metal M selected from a group consisting of metals having a standard electrode potential more negative than that of Ni. The catalyst material particle includes Ni as its primary component, and further includes the metal M. The solid electrolyte particle includes a ceria-based oxide as its primary component, and further includes the metal M.

A second aspect of the present disclosure provides a solid oxide-type electrochemical cell having the fuel electrode layer described as the first aspect, a solid electrolyte layer, and an air electrode layer, which is formed as a counter electrode to the fuel electrode layer, in this order. The solid electrolyte layer has an electrolyte body layer in contact with the fuel electrode layer. The electrolyte body layer includes a ceria-based oxide as its primary component, and further includes at least one metal M selected from a group consisting of metals having a standard electrode potential more negative than that of Ni.

### BRIEF DESCRIPTION OF THE DRAWINGS

In the accompanying drawings:

FIG. 1 shows a schematic cross-section view along a thickness direction of a fuel electrode layer, according to a first embodiment;

FIG. 2 is an enlarged schematic view of an area enclosed by a square in FIG. 1;

FIG. 3 is a schematic diagram explaining a mechanism to suppress degradation of the fuel electrode layer due to migration of Ni, according to the first embodiment;

FIG. 4 is a diagram illustrating the fuel electrode layer of a first comparative embodiment corresponding to FIG. 2;

FIG. 5 is a diagram schematically illustrating a first configuration of a laminated structure of an electrochemical cell, according to a second embodiment;

FIG. 6 is a diagram schematically illustrating a second configuration of the stacked structure of the electrochemical cell, according to the second embodiment;

FIG. 7 is a graph illustrating XRD measurement results of raw materials which are synthesized in Experimental Example 1 and used to prepare the fuel electrode layer;

FIG. 8 is a diagram illustrating SEM-EDX analysis results of a fuel electrode layer in an electrochemical cell of Specimen 1 obtained in Experimental Example 1;

FIG. 9 is a diagram illustrating SEM-EDX analysis results of a fuel electrode layer in an electrochemical cell of Specimen 1C obtained in Experimental Example 1.

FIG. 10 is a graph illustrating a relationship between operating time (h) for the durability test and voltage (V) in the electrochemical cells of Specimen 1 and Specimen 1C obtained in Experimental Example 1;

FIG. 11 is a graph illustrating a relationship between the content of Cr (mol %) and initial voltage (V) and a relationship between the content of Cr (mol %) and a voltage variation (V) in each electrochemical cell of Specimens 2 to 7 and Specimen 2C obtained in Experimental Example 2;

FIG. 12 is a diagram illustrating SEM-EDX analysis results of a fuel electrode layer in an electrochemical cell of Specimen 1 obtained in Experimental Example 3 (however, measurement regions are different from those in FIG. 8); and

FIG. 13 is a graph illustrating mass percentages of a Ni element, a Cr element, and an O element in regions P1, P2, and P3 obtained in Experimental Example 3, where the regions P1 and P2 are regions in which Cr is concentrated, and the region P3 is a region in which Ni is primarily contained.

### DETAILED DESCRIPTION OF THE PREFERRED EMBODIMENTS

In JP5244423B2 (Japanese Patent No. 5244423), a hydrogen electrode (corresponding to a fuel electrode layer) of an electrochemical cell is proposed. The hydrogen electrode includes: an oxide sintered body, which has metal particles on its surface and is covered by a mixed conductive film on the surface together with the metal particles; and a sintered body having ionic conductivity. Here, the oxide sintered body is an Al-based oxide or an Mg-based oxide, and the metal particles are a Ni metal or a similar material.

The same document also describes the following points. The metal particles are highly compatible with Al₂O₃ as a base material and firmly bonded to Al₂O₃. Therefore, the metal particles do not migrate easily when exposed to a high-temperature reducing atmosphere. The metal particles are microparticles and isolated particles. Therefore, a volume expansion of the metal particles is locally suppressed even in the case of rapid oxidation, suppressing damage thereto.

A fuel electrode layer of a solid oxide-type electrochemical cell is exposed to the high-temperature reducing atmosphere during the cell operation. When a fuel electrode layer made of a conventional composite material is exposed to a high-temperature reducing atmosphere during cell operation, grain growth, agglomeration, and migration of Ni occur. As a result, the fuel electrode layer deteriorates.

During the degradation of the fuel electrode layer, Ni migrates due to wetting and spreading (decrease in surface tension) of Ni in the high-temperature reducing atmosphere. The wetting and spreading of Ni is caused by a decrease in a contact angle due to a decrease in a surface energy difference by the electrostatic energy of a capacitor formed between a catalyst material and a solid electrolyte material (this is called the “electrowetting”).

However, there is a limit to reducing the decrease in the surface energy difference and the wetting and spreading of Ni solely by combining the catalyst and solid electrolyte materials. Furthermore, there are restrictions on materials that can be selected from the viewpoint of ensuring the electrode activity of the fuel electrode layer. Thus, it is difficult to prevent the degradation of the fuel electrode layer due to the migration of Ni with the above type of improvement.

According to the technology disclosed in JP5244423B2, adding an Al-based oxide or a similar material is necessary, to combine Ni with the Al-based oxide or a similar material. Without the Al-based oxide, it is impossible to suppress the degradation of the fuel electrode layer due to the migration of Ni.

In view of the above, the present disclosure aims to provide a fuel electrode layer capable of suppressing degradation due to migration of Ni, and a solid oxide-type electrochemical cell using this fuel electrode layer.

A first aspect of the present disclosure is a fuel electrode layer for use in a solid oxide-type electrochemical cell. The fuel electrode layer has catalyst material particles, solid electrolyte particles, and at least one metal M selected from a group consisting of metals having a standard electrode potential more negative than that of Ni. The catalyst material particle includes Ni as its primary component, and further includes the metal M. The solid electrolyte particle includes a ceria-based oxide as its primary component, and further includes the metal M.

A second aspect of the present disclosure is a solid oxide-type electrochemical cell having the fuel electrode layer described as the first aspect, a solid electrolyte layer, and an air electrode layer, which is formed as a counter electrode to the fuel electrode layer, in this order. The solid electrolyte layer has an electrolyte body layer in contact with the fuel electrode layer. The electrolyte body layer includes a ceria-based oxide as its primary component, and further includes at least one metal M selected from a group consisting of metals having a standard electrode potential more negative than that of Ni.

A fuel electrode layer of the present disclosure has the above configuration. According to this configuration, when the fuel electrode layer is exposed to a high-temperature reducing atmosphere during cell operation with the applied voltage, at an interface between catalyst material particles and solid electrolyte particles, metal M in the catalyst particles reacts with O²⁻ before Ni does. Additionally, the metal M in the solid electrolyte particles also reacts with O²⁻. As a result, an oxide of the metal M is formed. According to the above fuel electrode layer, the catalyst material particles can be fixed to the solid electrolyte particles by using a bonding force via the oxygen. Therefore, wetting and spreading (decrease in surface tension) of Ni in the high-temperature reducing atmosphere during cell operation with the applied voltage are suppressed. As a result, degradation of the fuel electrode layer due to migration of Ni can be suppressed.

An electrochemical cell of the present disclosure has the above configuration. According to this configuration, the electrochemical cell can suppress degradation of a fuel electrode layer due to migration of Ni even when the fuel electrode layer is exposed to a high-temperature reducing atmosphere during cell operation with the applied voltage. Therefore, according to the above electrochemical cell, the fuel electrode layer, which is an electrode, has excellent durability.

The reference signs in parentheses in the claims or the aspects to solve the problem indicate the correspondence with specific structural elements described in embodiments to be described later, and thus, do not limit the technical scope of the present disclosure in any way.

A fuel electrode layer and an electrochemical cell according to each embodiment will be described in detail below, referring to the drawings. Note that the descriptions in the following embodiment do not limit the fuel electrode layer and electrochemical cell. Lower and upper limits of numerical value ranges described in the following embodiment may be combined arbitrarily as necessary.

### First Embodiment

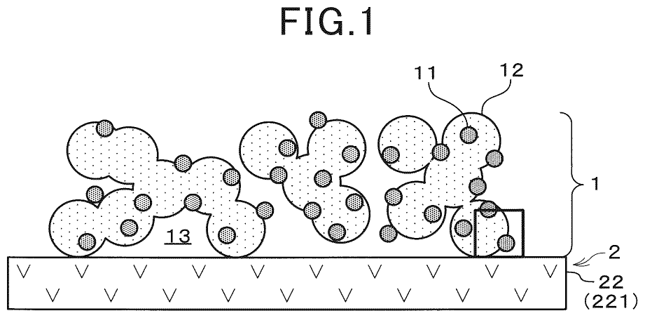

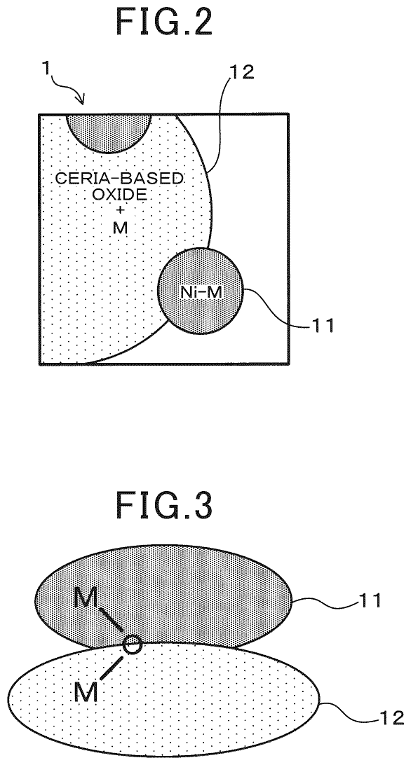

A fuel electrode layer of the present embodiment is described referring to FIGS. 1 through 4. As shown in FIGS. 1 to 3, a fuel electrode layer 1 of the present embodiment can be used in a solid oxide-type electrochemical cell 2. The fuel electrode layer 1 of the present embodiment is preferably used in the electrochemical cell 2 having a solid electrolyte layer 22 in contact with the fuel electrode layer 1, and is suitable for the solid electrolyte layer 22 with a ceria-based oxide as the electrolyte. Note that the detailed configuration of the electrochemical cell 2 is described in detail in a second embodiment.

The fuel electrode layer 1 of the present embodiment has catalyst material particles 11, solid electrolyte particles 12, and metal M. The metal M is a metallic element, and because it is difficult to indicate the metal M with reference signs in the drawings, the reference sign is omitted.

In FIG. 1, the fuel electrode layer 1 is illustrated as having further voids 13. Also shown in FIG. 1 is an example in which a particle size of each catalyst material particle 11 is smaller than a particle size of each solid electrolyte particle 12, and each catalyst material particle 11 is adhered to a surface of each solid electrolyte particle 12. A relationship between the particle sizes of the catalyst material particle 11 and solid electrolyte particle 12 can be observed as follows. First, an image of a cross-section of the fuel electrode layer 1 is acquired using a scanning electron microscope (SEM). From the acquired SEM image, average particle sizes of ten particles for each of the catalyst material particles 11 and solid electrolyte particles 12 are calculated. Then, the calculated average particle sizes are compared.

In the fuel electrode layer 1, the metal M is at least one metal selected from a group consisting of metals having a standard electrode potential more negative than that of Ni. In terms of the standard electrode potential, a metal with a larger positive potential is more likely to be reduced. In comparison, a metal with a larger negative potential is more likely to be oxidized. In other words, the more negative the standard electrode potential, the greater the ionization tendency of the metal. Ni has a standard electrode potential of −0.257 and a melting point (metallic state, hereinafter omitted) of 1455° C. Examples of the metal M include metals such as Co (standard electrode potential: −0.277, melting point: 1495° C.), Cd (standard electrode potential: −0.403, melting point: 321° C.), Fe (standard electrode potential: −0.447, melting point: 1538° C.), Cr (standard electrode potential: −0.744, melting point: 1907° ° C.), V (standard electrode potential: −1.130, melting point: 1910° C.), Mn (standard electrode potential: −1.185, melting point: 1246° C.), Mg (standard electrode potential: −1.55, melting point: 650° C.), Al (standard electrode potential: −1.6, melting point: 660.3° C.), and similar metals. One or more types of these metals may be used in combination.

The catalyst material particle 11 contains Ni as its primary component, and further contains the metal M. The expression “contains Ni as its primary component” means that a content of Ni in the catalyst material particle 11 is 70 mass % (% by mass) or more. When the content of Ni is less than 70 mass %, there is a concern that a function of generating and outputting hydrogen may be reduced. From the viewpoints of catalytic activity and electron conductivity, and the like, the content of Ni may preferably be 80 mass % or more, more preferably 85 mass % or more, even more preferably 90 mass % or more, and even more preferably 95 mass % or more. Examples of the catalyst material particles 11 include Ni particles containing the metal M (including alloy particles of Ni and the metal M) (hereinafter referred to as “Ni-M particles”), and similar alloys.

In the catalyst material particle 11, the metal M is dispersed within the catalyst material particle 11 in a cross-sectional view of the catalyst material particle 11. This configuration has advantages such as minimizing the decrease in catalytic activity. Examples of such catalyst material particles 11 include a particle in which the metal M is dispersed within the Ni particle, a particle in which the metal M diffuses from a surface to the interior of the Ni particle, and similar particles. Note that a diffusion rate of the metal M in the Ni particle is very fast because it is metal-to-metal, and a situation in which metal M is present in Ni with a specific concentration distribution is usually unlikely to occur.

The solid electrolyte particle 12 contains a ceria-based oxide as its primary component, and further contains the metal M. The expression “contains a ceria-based oxide as its primary component” means that a content of the ceria-based oxide in the solid electrolyte particle 12 is 60 mass % or more. When the content of the ceria-based oxide is less than 60 mass %, there is a concern that the function of generating and outputting hydrogen may be reduced. From the viewpoint of oxygen ionic conductivity and particle strength, the content of the ceria-based oxide may preferably be 65 mass % or more, more preferably 70 mass % or more, even more preferably 75 mass % or more, and even more preferably 80 mass % or more. Examples of the solid electrolyte particles 12 include a ceria-based oxide particle containing the metal M, and similar particles.

Examples of the ceria-based oxides contained in the solid electrolyte particles 12 include ceria (CeO₂) doped with one or more elements selected from Gd, Sm, Y, Sc, La, Nd, Yb, Ca, and Ho, as well as ceria. One or more types of these elements may be used in combination. From the viewpoint of excellent oxygen ionic conductivity at a relatively low temperature, and the like, the above ceria-based oxide may preferably be ceria doped with at least one of Gd and Sm, more preferably ceria doped with Gd.

The metal M can be present in the solid electrolyte particle 12 with a concentration distribution from a surface to the interior of the solid electrolyte particle 12 in a cross-sectional view of the solid electrolyte particle 12. Specifically, the metal M can be present in such a way that its concentration decreases from the surface to the interior of the solid electrolyte particle 12, in a cross-sectional view of the solid electrolyte particle 12. This configuration has advantages such as minimizing the decrease in oxygen ionic conductivity. Examples of such solid electrolyte particles 12 include a particle in which the metal M is present with a concentration distribution from a surface to the interior of the ceria-based oxide particle, a particle in which the metal M diffuses from the surface to the interior of the ceria-based oxide particle, and similar particles. Note that the diffusion rate of the metal M in the ceria-based oxide particle is slow. Therefore, the metal M can be present with a specific concentration distribution from the surface to the interior of the oxide (that is, the metal M can be present with a high concentration at the surface of the ceria-based oxide particle and a low concentration in the interior of the ceria-based oxide particle).

The state of presence of the metal M in the catalyst material particle 11 and solid electrolyte particle 12, as described above, can be observed through scanning electron microscope-energy dispersive X-ray spectroscopy (SEM-EDX; hereinafter referred to as “SEM-EDX analysis”).

The fuel electrode layer 1 of the present embodiment has the above configuration. That is, in the fuel electrode layer 1 of the present embodiment, the metal M, which is a metal having a standard electrode potential more negative than that of Ni, is contained in both the catalyst material particles 11 and the solid electrolyte particles 12. According to this configuration, when the fuel electrode layer 1 is exposed to a high-temperature reducing atmosphere during cell operation with the applied voltage, at an interface between the catalyst material particles 11 and the solid electrolyte particles 12, the metal M in the catalyst particles 11 reacts with O²⁻ before Ni does. Additionally, the metal M in the solid electrolyte particles 12 also reacts with O²⁻. As a result, an oxide of the metal M is formed. In other words, at the interface between the catalyst material particle 11 and the solid electrolyte particle 12, a secondary metal (metal M) other than a primary metal (Ni) contained in the catalyst material particle 11 forms an oxide phase. According to the fuel electrode layer 1 of the present embodiment, the catalyst material particles 11 can be fixed to the solid electrolyte particles 12 by using a bonding force via the oxygen. In other words, according to the fuel electrode layer 1 of the present embodiment, the bonding force between the catalyst material particles 11 and the solid electrolyte particles 12 is enhanced. In the fuel electrode layer 1 of the present embodiment, an oxide contained in the solid electrolyte particles 12 is not a zirconia-based oxide but a ceria-based oxide with oxygen storage capacity (OSC). Therefore, it is believed that this is advantageous in terms of ensuring the bonding between the metal M and O²⁻. According to the fuel electrode layer 1 of the present embodiment, wetting and spreading (decrease in surface tension) of Ni in the high-temperature reducing atmosphere during cell operation with the applied voltage are suppressed. As a result, degradation of the fuel electrode layer 1 due to migration of Ni can be suppressed.

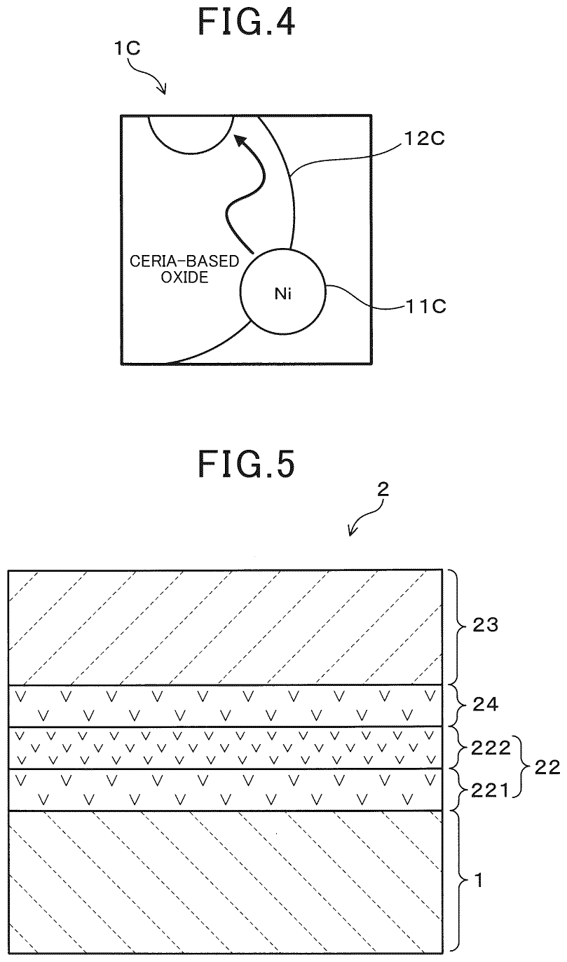

FIG. 4 shows a fuel electrode layer 1C of a first comparative embodiment, including Ni particles 11C without the metal M and ceria-based oxide particles 12C without the metal M. As shown in FIG. 4, for example, in the fuel electrode layer 1C of the first comparative embodiment, when the fuel electrode layer 1C is exposed to a high-temperature reducing atmosphere during cell operation with the applied voltage, a surface energy difference decreases by the electrostatic energy of a capacitor formed between the Ni particle 11C and the ceria-based oxide particle 12C, and a contact angle between the Ni particle 11C and the ceria-based oxide particle 12C decreases. As a result, in the fuel electrode layer 1C of the first comparative embodiment, the Ni particles 11C, which lack the bonding to the ceria-based oxide particles 12C, wet and spread out. This is due to the electrowetting effect, and the following equation can be used to understand the cause of this effect, since the contact angle between the Ni particle 11C and the ceria-based oxide particle 12C is dependent on the voltage. Note that the electrowetting effect is defined as the change in a solid-electrolyte contact angle due to an applied potential difference between the solid and the electrolyte. Therefore, the configuration of the fuel electrode layer 1C of the first comparative embodiment cannot suppress the degradation of the fuel electrode layer 1C due to the migration of Ni.

$$cos θ ( V ) = cos {θ}_{0} - ( C / 2 ) {V}^{2}$$

θ(V): the contact angle of the catalyst material particle 11 to the solid electrolyte particle 12 when the voltage is applied to the electrode;
θ₀: the contact angle of the catalyst material particle 11 to the solid electrolyte particle 12 when the voltage is not applied to the electrode (no load is applied);
C: the capacitor component between the catalyst material particle 11 and the solid electrolyte particle 12; and
V: the applied voltage.

A fuel electrode layer of a second comparative embodiment, in which zirconia-based oxide particles containing the metal M are used instead of ceria-based oxide particles containing the metal M, is also described, although it is not shown in the figures. In the fuel electrode layer of the second comparative embodiment, it is difficult to ensure the bonding between the metal M and O²⁻, even though a zirconia-based oxide contains the metal M, because the zirconia-based oxide is stable. As a result, a bonding force between the Ni particles and the zirconia-based oxide particles does not increase. Therefore, in the fuel electrode layer of the second comparative embodiment, the degradation of the fuel electrode layer due to the migration of Ni cannot be suppressed.

In the fuel electrode layer 1 of the present embodiment, for example, the metal M may preferably be at least one selected from a group consisting of Cr, V, and Mn. In this case, the melting point of the metal M is higher than an operating temperature of a solid oxide-type electrochemical cell (e.g., the temperature of 550° C. or more and 750° C. or less), which ensures its material stability. Additionally, in this type of metal M, the standard electrode potential is sufficiently more negative compared to that of Ni, which helps effectively suppress the migration of Ni and reduces environmental burdens, such as toxicity. The metal M may preferably contain at least Cr from the viewpoints of suppressing electrical resistance and preventing poisoning of the electrolyte material.

In the fuel electrode layer 1 of the present embodiment, a concentration of the metal M in the solid electrolyte particles 12 is preferably higher than that of the metal M in the catalyst material particles 11. According to this configuration, the migration of Ni can be more effectively suppressed. Thus, the electrode performance of the fuel electrode layer 1 can be ensured. This is believed to be because the presence of a large amount of the metal M in the solid electrolyte particles 12, which are stable under a high temperature, can suppress the occurrence of the electrowetting effect described above. It can further obtain the anchoring effect and effectively suppresses the change in bonding. The concentrations of the metal M in each of the solid electrolyte particles 12 and the catalyst material particles 11 can be measured by SEM-EDX analysis.

In the fuel electrode layer 1 of the present embodiment, a content of the metal M relative to Ni contained in the fuel electrode layer 1 is preferably within a range of 1 mol % (% by mole) or more and 30 mol % or less in terms of oxide. The content of the above metal M of 1 mol % or more ensures the suppression effect of the degradation of the fuel electrode layer 1 due to the migration of Ni. The content of the above metal M may preferably be 2 mol % or more, and even more preferably 3 mol % or more. On the other hand, when the content of the above metal M is 30 mol % or less, an electrode reaction in the fuel electrode layer 1 is hardly inhibited. Therefore, when the content of the above metal M is 30 mol % or less, the degradation of the fuel electrode layer 1 due to the migration of Ni can be effectively suppressed while maintaining the function of the electrochemical cell 2 to generate and output hydrogen. The content of the above metal M may preferably be 25 mol % or less, even more preferably 20 mol % or less, even more preferably 15 mol % or less, and even more preferably 10 mol % or less.

The content of the above metal M can be measured as follows. First, a sample cut from the fuel electrode layer 1 is quantitatively analyzed by inductively coupled plasma atomic emission spectrometry (ICP-AES) to obtain the percentage by mass (i.e., mass %) of the metal M. Then, the obtained percentage by mass of the metal M is converted to a molecular weight of the oxide of the metal M to obtain the percentage by mole (i.e., mol %). For example, an “SPS-3500”, manufactured by Hitachi High-Technologies Corporation, can be used as the ICP-AES system.

In the fuel electrode layer 1 of the present embodiment, the metal M contained in the fuel electrode layer 1 preferably has a larger ratio of the presence as the oxide compared to Ni contained in the fuel electrode layer 1. According to this configuration, it is easy to exhibit the above-mentioned mechanism for suppressing the degradation of the fuel electrode layer 1 due to the migration of Ni, and the improvement of the durability of the fuel electrode layer 1 can be ensured.

In the fuel electrode layer 1, the ratio of the presence as the oxide of the metal M and the ratio of the presence as the oxide of Ni can be measured as follows. First, the cross-section of the catalyst material particles 11 in the fuel electrode layer 1 is subjected to a surface process with ion beam milling, and mapping images of a Ni element, an O element, and a metal M element are acquired for the same location by the SEM-EDX analysis. Then, the acquired mapping images of each element are compared with each other. In the mapping image of the metal M element, regions are arbitrarily selected which are rich in the metal M (two concentration regions: these regions may be referred to as P1 and P2, respectively). Further, a region is arbitrarily selected which Ni is primarily contained and not rich in the metal M (one non-concentration region: this region may be referred to as P3). Then, a mass fraction (e.g., the percentage by mass) of the O element in the selected regions P1 to P3 is measured. Next, the mass fraction of the O element in the region P3, where Ni is primarily contained, is compared with the mass fraction of the O element in the regions P1 and P2, which are concentration regions of the metal M. As a result, when a relationship of (mass fraction of the O element in the region P3)<(mass fraction of the O element in the region P1) and (mass fraction of the O element in the region P3)<(mass fraction of the O element in the region P2) is satisfied, the metal M contained in the fuel electrode layer 1 is determined to have a larger ratio of the presence as the oxide than Ni contained in the fuel electrode layer 1. That is, the ratio of metal M contained in the fuel electrode layer 1 as the oxide can be understood to be greater than that of Ni contained in the fuel electrode layer 1 as the oxide.

In the fuel electrode layer 1 of the present embodiment, a volume ratio of the catalyst material particles 11 to the solid electrolyte particles 12 may be, for example, catalyst material particles:solid electrolyte particles=20:80 to 80:20. The volume ratio of the catalyst material particles 11 to the solid electrolyte particles 12 may preferably be 30:70 to 70:30, more preferably 35:65 to 65:35, and more preferably 40:60 to 60:40.

In the fuel electrode layer 1 of the present embodiment, a thickness of the fuel electrode layer 1 may be, for example, within a range of 10 μm or more and 100 μm or less. The thickness of the fuel electrode layer 1 is the arithmetic mean of thickness measurements taken at nine points in the fuel electrode layer 1, which are measured in the cross-section when the fuel electrode layer 1 is cut along its thickness direction.

The description of a second embodiment, described below, can be applied to the first embodiment alone or in any combination as necessary.

### Second Embodiment

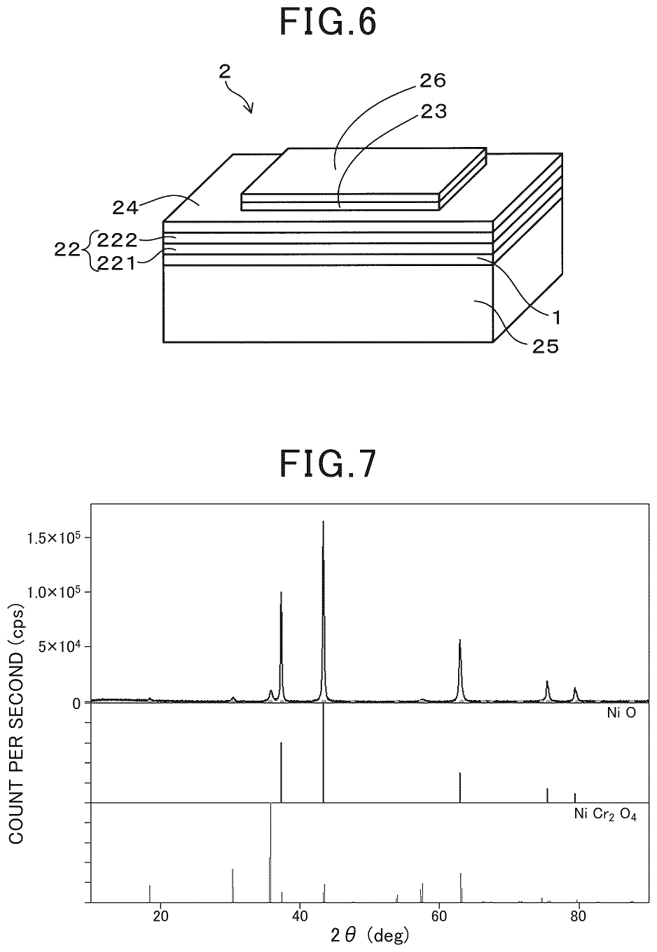

An electrochemical cell of the present embodiment is described referring to FIGS. 5 and 6. In the present embodiment and thereafter, the same reference signs used in the previous embodiments represent the same components, etc., as those in the previous embodiments, unless otherwise indicated.

As shown in FIGS. 5 and 6, an electrochemical cell 2 of the present embodiment is a solid oxide-type electrochemical cell. The electrochemical cell 2 of the present embodiment has a fuel electrode layer 1, a solid electrolyte layer 22, and an air electrode layer 23, in this order. FIGS. 5 and 6 show examples where the fuel electrode layer 1, the solid electrolyte layer 22, and the air electrode layer 23 are stacked in this order. In the same figures, the fuel electrode layer 1 and the solid electrolyte layer 22 are bonded to each other, and the solid electrolyte layer 22 and the air electrode layer 23 are bonded through an intermediate layer 24 (to be described later).

The electrochemical cell 2 of the present embodiment may have a flat plate-shaped cell structure, as shown in FIGS. 5 and 6. The electrochemical cell 2 may have a cylindrical cell structure, which is not shown. The electrochemical cell 2 of the present embodiment may have an electrolyte-supported structure, an electrode-supported structure (e.g., a fuel electrode layer-supported structure, or an air electrode layer-supported structure), a metal-supported structure, or the like.

The fuel electrode layer 1 is an electrode layer to which fuel is supplied. In other words, the fuel electrode layer 1 corresponds to an electrode layer with electrode activity that functions as a fuel electrode. In the electrochemical cell 2 of the present embodiment, the fuel electrode layer 1 of the first embodiment can be applied as the fuel electrode layer 1.

The solid electrolyte layer 22 is a layer that functions as an electrolyte in the electrochemical cell 2 and has oxygen ionic conductivity. The solid electrolyte layer 22 has an electrolyte body layer 221 in contact with the fuel electrode layer 1. The solid electrolyte layer 22 may be formed as a single layer or multiple layers. FIGS. 5 and 6 show examples where the solid electrolyte layer 22 is formed of two layers: the electrolyte body layer 221 in contact with the fuel electrode layer 1; and an electron blocking layer 222 formed on a second surface opposite a first surface in contact with the fuel electrode layer 1. The electrolyte body layer 221 is an electrolyte layer that functions as a main structure of the solid electrolyte layer 22 and also functions as the electrolyte of the electrochemical cell 2. When the solid electrolyte layer 22 is formed as a single layer, that single layer corresponds to the electrolyte body layer 221. The electron blocking layer 222 is a layer to block migration of electrons. When the solid electrolyte layer 22 has the electron blocking layer 222, the migration of electrons is blocked by the solid electrolyte layer 22. Therefore, in addition to oxygen ionic conductivity, the electrolyte body layer 221 may also have electron conductivity, for example, in a reducing atmosphere. As described above, the solid electrolyte layer 22 of the present embodiment has the electrolyte body layer 221 in contact with the fuel electrode layer 1, and the composition of the layers is not particularly limited as long as a layer is formed to function as the electrolyte of the electrochemical cell 2.

Although it is not shown in the figures, the solid electrolyte layer 22 stacked on a surface of the fuel electrode layer 1 may be formed to cover an outer peripheral surface of the fuel electrode layer 1 and a fuel diffusion layer 25 described below. According to this configuration, fuel gas leakage can be suppressed with a relatively simple structure. In this case, at least one of the electrolyte body layer 221 and the electron blocking layer 222 can be formed to cover the outer peripheral surface of the fuel electrode layer 1 and the fuel diffusion layer 25.

The air electrode layer 23 is an electrode layer that functions as a counter electrode to the fuel electrode layer 1. In other words, the air electrode layer 23 corresponds to an electrode layer with electrode activity that functions as an air electrode.

The electrochemical cell 2 of the present embodiment can have an intermediate layer 24 between the solid electrolyte layer 22 and the air electrode layer 23, as shown in FIGS. 5 and 6. The intermediate layer 24 is mainly a layer (i.e., a reaction suppression layer) to suppress the reaction between materials of the solid electrolyte layer 22 and materials of the air electrode layer 23. FIGS. 5 and 6 show examples where the intermediate layer 24 is in contact with the solid electrolyte layer 22 and the air electrode layer 23 and bonded to these layers.

The electrochemical cell 2 of the present embodiment can have a fuel diffusion layer 25 formed on a second surface opposite a first surface of the fuel electrode layer 1, which is in contact with the solid electrolyte layer 22, as shown in FIG. 6. The fuel diffusion layer 25 is a layer that functions to diffuse the fuel before supplying it to the fuel electrode layer 1. The fuel diffusion layer 25 can also have a function of diffusing electrons. When the electrochemical cell 2 has the fuel diffusion layer 25, the diffused fuel can be supplied to the fuel electrode layer 1. In addition to the fuel diffusion function, the fuel diffusion layer 25 can also be formed to function as a support layer that supports each layer in the fuel electrode layer 1. The fuel diffusion layer 25 may also be a layer that functions as a current collector in the fuel electrode layer 1.

The electrochemical cell 2 of the present embodiment may also have a current-collecting layer 26 for the air electrode formed on a second surface opposite a first surface of the air electrode layer 23, which is in contact with the intermediate layer 24, as shown in FIG. 6. The current-collecting layer 26 for the air electrode is a layer that functions as a current collector for the air electrode layer 23.

In the electrochemical cell 2, a thickness of the fuel electrode layer 1 may be, for example, within a range of 10 μm or more and 100 μm or less. A thickness of the solid electrolyte layer 22 may be, for example, within a range of 2 μm or more and 20 μm or less. A thickness of the electrolyte body layer 221 may be, for example, within a range of 1 μm or more and 15 μm or less. A thickness of the electron blocking layer 222 may be, for example, within a range of 1 μm or more and 15 μm or less. A thickness of the air electrode layer 23 may be, for example, within a range of 10 μm or more and 100 μm or less. A thickness of the intermediate layer 24 may be, for example, within a range of 1 μm or more and 20 μm or less. A thickness of the fuel diffusion layer 25 may be, for example, within a range of 100 μm or more and 800 μm or less. A thickness of the current-collecting layer 26 for the air electrode may be, for example, within a range of 1 μm or more and 100 μm or less. An average value of the thickness of each layer can be determined in the same way as the thickness of the fuel electrode layer 1 described above in the first embodiment.

In the electrochemical cell 2 having the stacked structure described above, the electrolyte body layer 221 contains a ceria-based oxide as its primary component and further contains metal M. The expression “contains a ceria-based oxide as its primary component” means that the content of the ceria-based oxide in the electrolyte body layer 221 is 60 mass % or more. When the content of ceria-based oxide is less than 60 mass %, there is a concern that a function of generating and outputting hydrogen may be reduced. From the viewpoint of oxygen ionic conductivity and particle strength, the content of the ceria-based oxide may preferably be 70 mass % or more, more preferably 80 mass % or more, and even more preferably 90 mass % or more. The electrolyte body layer 221 can be made of the ceria-based oxide containing the metal M.

Examples of the ceria-based oxides contained in the electrolyte body layer 221 include ceria (CeO₂) doped with one or more elements selected from Gd, Sm, Y, Sc, La, Nd, Yb, Ca, and Ho, as well as ceria. One or more types of these elements may be used in combination. From the viewpoint of excellent oxygen ionic conductivity at a relatively low temperature, and the like, the above ceria-based oxide may preferably be ceria doped with at least one of Gd and Sm, more preferably ceria doped with Gd.

The metal M can be present in the electrolyte body layer 221 with a concentration distribution from a surface of the electrolyte body layer 221, which is in contact with the fuel electrode layer 1, to the interior of the electrolyte body layer 221 in a cross-sectional view of the electrolyte body layer 221. Specifically, the metal M can be present in such a way that its concentration decreases from the surface of the electrolyte body layer 221, which is in contact with the fuel electrode layer 1, to the interior of the electrolyte body layer 221, in the cross-sectional view of the electrolyte body layer 221. This configuration has advantages such as preventing poisoning of the electron blocking layer 222 and maintaining oxygen ionic conductivity. Examples of such configurations of the electrolyte body layer 221 include a configuration in which the metal M is present with a concentration distribution from a surface to the interior of a ceria-based oxide layer in contact with the fuel electrode layer 1, a configuration in which the metal M diffuses from the surface to the interior of the ceria-based oxide layer, and similar configurations. Note that the diffusion rate of the metal M in the ceria-based oxide layer is slow. Therefore, the metal M can be present with a specific concentration distribution from the surface to the interior of the ceria-based oxide layer (that is, the metal M can be present with a high concentration at the surface of the ceria-based oxide layer and a low concentration in the interior of the ceria-based oxide layer).

The state of presence of the metal M in the electrolyte body layer 221, as described above, can be observed through the SEM-EDX analysis.

The electrochemical cell 2 of the present embodiment has the above configuration. According to this configuration, the electrochemical cell 2 can suppress degradation of the fuel electrode layer 1 due to migration of Ni even when the fuel electrode layer 1 is exposed to a high-temperature reducing atmosphere during cell operation with the applied voltage. Therefore, according to the electrochemical cell 2 of the present embodiment, the fuel electrode layer 1, which is an electrode, has excellent durability.

The electrochemical cell 2 of the present embodiment also has the following advantages. Specifically, in other words, in the electrochemical cell 2 of the present embodiment, the electrolyte body layer 221 in contact with the fuel electrode layer 1 is formed to use a material of the same property as the solid electrolyte particles 12 in the fuel electrode layer 1. Therefore, in the electrochemical cell 2 of the present embodiment, occurrence of a difference in wettability of Ni between the fuel electrode layer 1 and the electrolyte body layer 221 is suppressed. As a result, the electrochemical cell 2 of the present embodiment can better ensure the suppression of the degradation of the fuel electrode layer 1 due to the migration of Ni.

The electrochemical cell 2 described above is configured as a solid oxide-type cell, in which the fuel electrode layer 1 is configured as in the first embodiment and the electrolyte body layer 221 is configured as described above. If the cell is so configured, the materials and composition of the fuel diffusion layer 25, the electron blocking layer 222 of the solid electrolyte layer 22, the intermediate layer 24, the air electrode layer 23, and the current-collecting layer 26 for the air electrode are not limited. Each of these layers can be configured specifically as follows.

The fuel diffusion layer 25 may include, for example, electron conductive materials, oxide materials for the diffusion layer, and voids. Both the electron conductive materials and the oxide materials for the diffusion layer may be present as particles.

Examples of the electron conductive materials contained in the fuel diffusion layer 25 include an electron conductor (e.g., a metal and an alloy, hereinafter omitted) such as Ni, Ni alloys, Cu, Cu alloys, Co, Co alloys, and an oxide (oxide of a metal or an alloy, hereinafter omitted) of an electron conductor such as an Ni oxide (NiO, etc.), a Cu oxide, a Co oxide that becomes the electron conductor through reduction, and similar materials. One or more types of these materials may be used in combination. The electron conductive materials contained in the fuel diffusion layer 25 may or may not have catalytic activity. From the viewpoint of catalytic activity and the like, the electron conductive materials may preferably be Ni, Ni alloys, Ni oxides (such as NiO), and similar materials. The electron conductive materials may more preferably be Ni or NiO among these materials. Examples of the oxide materials for the diffusion layer include ceria (CeO₂), ceria, yttria-stabilized zirconia (YSZ), scandia-stabilized zirconia (ScSZ) doped with one or more elements selected from Gd, Sm, Y, Sc, La, Nd, Yb, Ca, and Ho, and other similar solid electrolyte materials. Furthermore, examples of the oxide materials for the diffusion layer include various oxides that are not the solid electrolyte materials, such as CaO and MgO. One or more types of these materials may be used in combination. From the viewpoint of excellent oxygen ionic conductivity at a relatively low temperature of about 700° C., and the like, the ceria-based oxide may preferably be ceria doped with at least one of Gd and Sm, more preferably, ceria doped with Gd.

When the solid electrolyte layer 22 has the electron blocking layer 222 in addition to the electrolyte body layer 221, as shown in FIGS. 5 and 6, for example, the electron blocking layer 222 may be made of solid electrolyte materials having oxygen ionic conductivity without electron conductivity. Examples of the solid electrolyte materials having oxygen ionic conductivity without electron conductivity include yttria-stabilized zirconia, scandia-stabilized zirconia, and similar materials. One or more types of these materials may be used in combination. The solid electrolyte layer 22 is generally formed densely to prevent gas permeation.

The intermediate layer 24 can be formed from a mixed material containing solid electrolyte materials having oxygen ionic conductivity and air electrode materials forming the air electrode layer 23, the solid electrolyte materials having oxygen ionic conductivity, or the like. The solid electrolyte materials having oxygen ionic conductivity contained in the intermediate layer 24 may or may not have electronic conductivity.

Examples of the solid electrolyte materials having oxygen ionic conductivity contained in the intermediate layer 24 include a ceria-based oxide, ceria and other similar solid electrolyte materials, yttria-stabilized zirconia, scandia-stabilized zirconia, and similar materials. One or more types of these materials may be used in combination.

The air electrode layer 23 may include, for example, catalyst materials for the air electrode, electrolyte materials for the air electrode, and voids. Both the catalytic material for the air electrode and the electrolyte material for the air electrode may be present as particles. The catalytic materials for the air electrode may be made of, for example, catalytic materials having electron conductivity and oxygen ionic conductivity. The electrolyte materials for the air electrode may be made of, for example, solid electrolyte materials having oxygen ionic conductivity.

Examples of the catalyst materials for the air electrode include a perovskite-type oxide containing La, Sr, and Co, a perovskite-type oxide containing Pr, Ba, and Co, a perovskite-type oxide containing Gd, Ba, and Co, a perovskite-type oxide containing Nd, Ba, and Co, and the like. One or more types of these oxides may be used in combination. Examples of the perovskite-type oxides containing La, Sr, and Co described above include a metal oxide represented by La₁₋ₓSrₓCoO₃₋₈ (0<x≤1, preferably 0.1≤x≤0.5), such as La_{0.6}Sr_{0.4}CoO₃. Examples of the perovskite-type oxides containing Pr, Ba, and Co include a metal oxide represented by Pr₂₋ₓBaₓCo₂O_{5+δ} (0.7≤x≤1.3, preferably 0.8≤x≤1). Examples of the perovskite-type oxides containing Gd, Ba, and Co include a metal oxide represented by Gd₂₋ₓBaₓCo₂O_{5+δ} (0.7≤x≤1.3, preferably 0.8≤x≤1). Examples of the perovskite-type oxides containing Nd, Ba, and Co include a metal oxide represented by Nd₂₋ₓBaₓCo₂O_{5+δ} (0.7≤x≤1.3, preferably 0.8≤x≤1). The above oxides may or may not have oxygen non-stoichiometry. Examples of the electrolyte materials for the air electrode include a ceria-based oxide and ceria described above. One or more types of these materials may be used in combination.

The current-collecting layer 26 for the air electrode may be made of current-collecting materials for the air electrode, having electron conductivity suitable for collecting the current on the air electrode side, which is exposed to a high-temperature oxidation atmosphere.

Examples of the current-collecting materials for the air electrode include a metal material such as Pt, Pt alloy, Ag, Ag alloy, Au, and an oxide with electron conductivity, such as a perovskite-type oxide containing La, Sr, and Co, and a perovskite-type oxide containing La, Ni, and Fe. One or more types of these materials may be used in combination.

The electrochemical cell 2 of the present embodiment can be used as at least one of a solid oxide electrolysis cell (SOEC) and a solid oxide fuel cell (SOFC). In other words, the electrochemical cell 2 of the present embodiment may operate as the SOEC or the SOFC. Furthermore, the electrochemical cell 2 of the present embodiment can be configured to switch between a SOEC mode, in which it functions as the SOEC, and a SOFC mode, in which it functions as the SOFC, allowing it to operate as either the SOEC or SOFC.

Specifically, when the electrochemical cell 2 of the present embodiment operates as the SOEC, the fuel electrode layer 1 can function as a hydrogen electrode. The fuel electrode layer 1 can be supplied with a water (H₂O)-containing gas, such as a gas containing water vapor, as fuel. In this case, the air electrode layer 23 can function as the oxygen electrode. The air electrode layer 23 may or may not be supplied with the gas, such as atmospheric air. When the electrochemical cell 2 of the present embodiment operates as the SOEC, this electrochemical cell 2 can be applied not only for water vapor electrolysis, but also for CO₂-water vapor co-electrolysis and CO₂-electrolysis. In the CO₂-water vapor co-electrolysis, the gas containing at least CO₂ and water vapor can be used as the fuel. In the CO₂-electrolysis, a CO₂-containing gas, including CO₂, can be used as the fuel. On the other hand, when the electrochemical cell 2 of the present embodiment operates as the SOFC, a hydrogen-containing gas, including hydrogen, can be supplied to the fuel electrode layer 1 as the fuel. In this case, atmospheric air or an oxygen-containing gas, including oxygen, can be supplied to the air electrode layer 23. The water-containing gas described above may include a reducing gas such as a hydrogen gas. The hydrogen-containing gas may include water vapor for humidification.

From the viewpoint of reducing cell resistance and achieving high output, the operating temperature of the electrochemical cell 2 of the present embodiment may preferably be 500° C. or more, more preferably 600° C. or more, and even more preferably 650° C. or more. From the viewpoint of efficiently suppressing reduction expansion, the operating temperature of the electrochemical cell 2 may preferably be 825° C. or less, more preferably 800° C. or less, and even more preferably 775° C. or less.

The components described in the first embodiment above can be applied to a second embodiment by selecting and combining one or more elements as needed.

### Experimental Example 1

### <Specimen 1 of Electrochemical Cell>

### —Paste for Forming Fuel Electrode Layer—

A paste for forming a fuel electrode layer was prepared as follows. First, NiO powder and Cr(NO₃)₃ were mixed in a solvent containing water and ethanol at a mass ratio of 1:1 at room temperature. The solvent was then evaporated and dried through heating while mixing and dispersing. This allowed Cr(NO₃)₃ to concentrate on each surface of NiO particles. This was then denitrated by heat treatment at 350° C. for 1 hour. This transformed Cr(NO₃)₃ on the surface of the NiO particles into Cr oxide. This was further heat-treated at 800° C. for 2 hours. This made a compound of NiO and CrOx. The compound was analyzed by XRD using an X-ray diffractometer (“MiniFlex”, manufactured by Rigaku Holdings Corporation). The XRD measurement results are shown in FIG. 7. As shown in FIG. 7, the results indicate that the compound above is a mixed crystal of NiCr₂O₄ and NiO, formed by the reaction of NiO and CrOx. In the present experimental example, a nitrate salt was used, but it is not limited to this. Other salts such as acetate, oxalate, and carbonate can also be used in the present experimental example.

The resulting mixed crystal particles were then mixed with terpineol (solvent), dispersant, a leveling agent, and an anti-settling agent, and a particle size was adjusted using a ball mill. Here, the particles were crushed so that an average particle size was within a range of 0.1 μm or more and 1.0 μm or less. The catalyst material slurry was thus obtained. The above-average particle size is defined as a d50 particle size (d50 particle diameter) when the cumulative frequency distribution, measured on a volume basis by laser diffraction and scattering, indicates 50% (hereinafter referred to as the same).

Next, the obtained catalyst material slurry was mixed with Gd-doped CeO₂ (hereinafter referred to as “GDC”) powder, which is a solid electrolyte material of a ceria-based oxide, and carbon (pore-forming material), and then further dispersed using the ball mill. An amount of Gd doped was 10 mol %. Next, an acrylic resin (binder) was added to the mixture and stirred. Then, mixing was performed using a three-roll mill. The above processes were performed to obtain the paste for forming the fuel electrode layer. In the present experimental example, Cr was selected as the metal M. Suppose another metal M other than Cr is selected. In that case, the catalyst material slurry containing crystal particles mixed NiO with a composite oxide containing Ni and the metal M, which is formed by the reaction of NiO and an oxide of the metal M, may be prepared according to the processes described above. The paste for forming the fuel electrode layer can then be prepared by mixing the catalyst material slurry and the ceria-based oxide.

### —Sheet for Forming Fuel Diffusion Layer—

A slurry was prepared by mixing NiO powder (average particle size: 0.4 μm), GDC powder (average particle size: 0.3 μm), carbon (pore-forming material), polyvinyl butyral, isoamyl acetate, and 1-butanol, using a ball mill. The slurry was coated in a layer on a resin sheet using a doctor blade method and allowed to dry. The resin sheet was then peeled off to prepare a sheet for forming a fuel diffusion layer. An amount of carbon in the sheet for forming the fuel diffusion layer is greater than that in the paste for forming the fuel electrode layer.

### —Sheet for Forming Electrolyte Body Layer—

A slurry was prepared by mixing GDC powder (average particle size: 0.3 μm), polyvinyl butyral, isoamyl acetate, and 1-butanol, using a ball mill. Thereafter, a sheet for forming an electrolyte body layer was prepared by the same process as that for the preparation of the sheet for forming the fuel diffusion layer described above.

### —Sheet for Forming Electron Blocking Layer—

A slurry was prepared by mixing yttria-doped ZrO₂ of 8 mol % (hereinafter referred to as “8YSZ”) powder (average particle size: 0.3 μm), polyvinyl butyral, isoamyl acetate, and 1-butanol, using a ball mill. Thereafter, a sheet for forming an electron blocking layer was prepared by the same process as that for preparing the sheet for forming the fuel diffusion layer described above.

### —Sheet for Forming Intermediate Layer—

A slurry was prepared by mixing GDC powder (average particle size: 0.3 μm), polyvinyl butyral, isoamyl acetate, and 1-butanol, using a ball mill. Thereafter, a sheet for forming an intermediate layer was prepared by the same process as that for forming the sheet for forming the fuel diffusion layer described above.

### —Paste for Forming Air Electrode Layer—

A paste for forming an air electrode layer was prepared by mixing LSC (La_{0.6}Sr_{0.4}CoO₃) powder (average particle size: 2.0 μm), ethyl cellulose, and terpineol, using a three-roll mill.

### <Preparation of Electrochemical Cell (Single Cell)>

An electrochemical cell of Specimen 1 was prepared as follows. First, a paste for forming a fuel electrode layer was applied to one side of a sheet for forming a fuel diffusion layer using a screen printing method, and then dried. This formed a sheet for forming the fuel electrode layer. Next, sheets for forming an electrolyte body layer, an electron blocking layer, and an intermediate layer were laminated onto the sheet for forming the fuel electrode layer in this order, and pressed using an isostatic pressing (IP) and molding method. The laminate was thus obtained. Press conditions included a temperature of 85° C., a pressure of 50 MPa, and a press time of 10 minutes. After the pressing above, the laminate was degreased. To improve the dimensional accuracy of the resulting cell, the dimensions of the laminate were adjusted by trimming the outer circumference of the laminate after pressing. The laminate was then sintered at 1350° C. for 2 hours in atmospheric air. As a result, the sintered body was obtained in which the fuel diffusion layer, the fuel electrode layer, the electrolyte body layer, the electron blocking layer, and the intermediate layer were laminated in this order.

Next, a paste for forming an air electrode layer was applied to a surface of an intermediate layer in the obtained sintered body using a screen printing method, and further sintered at 950° C. for 2 hours in atmospheric air. This formed the air electrode layer. In this case, the outer shape of the air electrode layer was smaller than that of a solid electrolyte layer (this layer was formed by a two-layer structure consisting of an electrolyte body layer and an electron blocking layer).

Next, an evaluation jig was attached to the sintered body with the air electrode layer formed to spatially separate a fuel electrode layer side and an air electrode layer side in the sintered body. Then, a gas seal structure was formed by sealing with glass. The fuel electrode layer was then activated (reduced) at a temperature of 650° C. in a hydrogen atmosphere.

By the above processes, the electrochemical cell (single cell) of Specimen 1 was obtained, in which the fuel diffusion layer (thickness: 300 μm), the fuel electrode layer (thickness: 25 μm), the electrolyte body layer (thickness: 3 μm), the electron blocking layer (thickness: 3 μm), the intermediate layer (thickness: 3 μm), and the air electrode layer (thickness: 25 μm) are laminated in this order. The content of Cr in the fuel electrode layer of Specimen 1 is 1 mol % in terms of oxide.

### <Electrochemical Cell of Specimen 1C>

The differences in preparation conditions between the electrochemical cells of Specimen 1 and Specimen 1C are as follows:
When preparing a paste for forming a fuel electrode layer in Specimen 1C, Cr(NO₃)₃ was not added, and NiO slurry was used as the catalyst material slurry, the NiO slurry not containing Cr;
8YSZ powder, which is a zirconia-based oxide, was mixed into the catalyst material slurry instead of the ceria-based oxide, as the solid electrolyte material;
When preparing a sheet for forming an electrolyte body layer in Specimen 1C, 8YSZ powder was used instead of the GDC powder; and
The solid electrolyte layer is formed by a single electrolyte body layer.

The electrochemical cell of Specimen 1C was prepared by the same process as that of Specimen 1, except for the above points.

### <Various Measurements and Evaluations>

### —SEM-EDX Analysis—

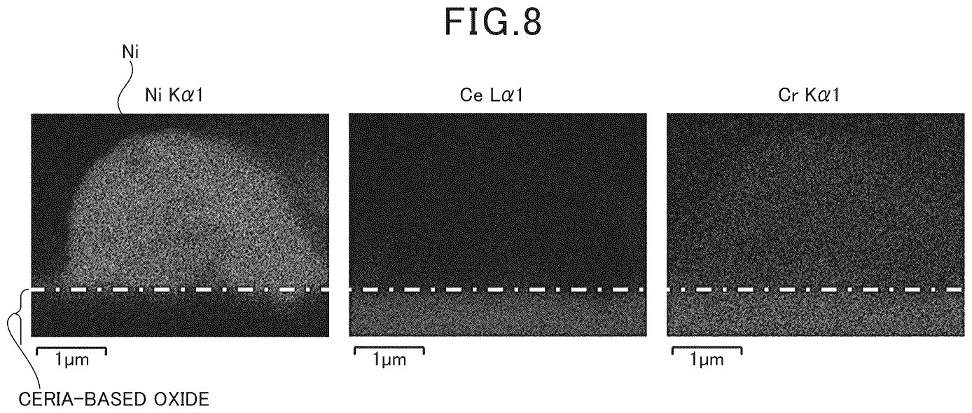

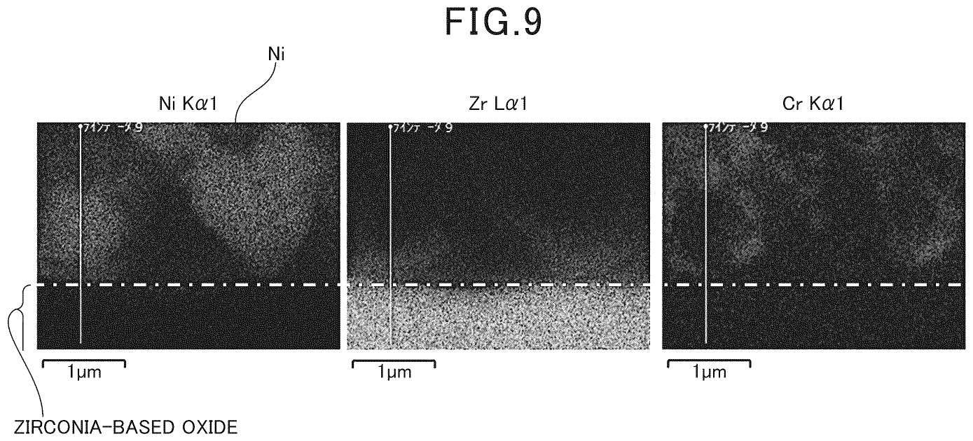

The SEM-EDX analysis was performed on the fuel electrode layers of the prepared electrochemical cells of Specimen 1 and Specimen 1C. Specifically, the cross-section of the catalyst material particles in the fuel electrode layer was subjected to the surface process with the ion beam milling, and the mapping images of the Ni element, the Ce element, the Zr element, and the Cr element were acquired for the same location by the SEM-EDX analysis. In the present experimental example, the primary component of the electrolyte body layer and the solid electrolyte particles is the same ceria-based oxide. Therefore, in the present experimental example, the catalyst material particles to be analyzed were selected from those that were certainly in contact with the electrolyte body layer, for reasons such as the ease of observing the diffusion of the Cr element. For the SEM-EDX analysis, an “EMAX Energy”, manufactured by HORIBA, Ltd., was used. The analysis results are shown in FIGS. 8 and 9.

As shown in FIG. 8, the analysis results indicate that Cr diffuses from the surface to the interior of the Ni particle and that Cr is dispersed within the Ni particle in Specimen 1, which uses the ceria-based oxide as the solid electrolyte material. In addition, it can be seen that Cr is present from the surface to the interior of the electrolyte body layer in contact with the fuel electrode layer in the solid electrolyte layer, even though raw materials that do not contain Cr are used in the electrolyte body layer in contact with the fuel electrode layer. This is because Cr, which is contained in the mixed crystal particles used in the catalyst material slurry, is diffused from the surface to the interior of the ceria-based oxide layer that forms the electrolyte body layer. It can be seen that Cr has a concentration distribution with a high concentration on the surface of the ceria-based oxide layer and a lower concentration toward the interior of the ceria-based oxide layer. The brightness of the mapping image of the Cr element indicates that the concentration of Cr in the ceria-based oxide is higher than that in the Ni particle.

From the above results, it was confirmed that in Specimen 1, the fuel electrode has the catalyst material particles containing Ni as its primary component and Cr, and the solid electrolyte particles containing the ceria-based oxide as its primary component and Cr. It was also confirmed that the concentration of Cr in the solid electrolyte particle was higher than that in the catalyst material particle.

In contrast, as shown in FIG. 9, for Specimen 1C, which used the zirconia-based oxide as the solid electrolyte material, Cr diffused from the surface to the interior of the Ni particle and Cr was dispersed within the Ni particle, as in Specimen 1C. However, Cr did not diffuse from the surface to the interior of the electrolyte body layer in contact with the fuel electrode layer, indicating that Cr is not present in the interior of the electrolyte body layer. In other words, it can be seen that the electrochemical cell of Specimen 1C is in a state where effects provided by the technology of the present disclosure (e.g., the electrochemical cell of Specimen 1) cannot be obtained.

From the above analysis results, it can be seen that in Specimen 1C, the fuel electrode has the catalyst material particles containing Ni as its primary component and also containing Cr, and the solid electrolyte particles containing the zirconia-based oxide as its primary component and not containing Cr.

### —Durability Test—

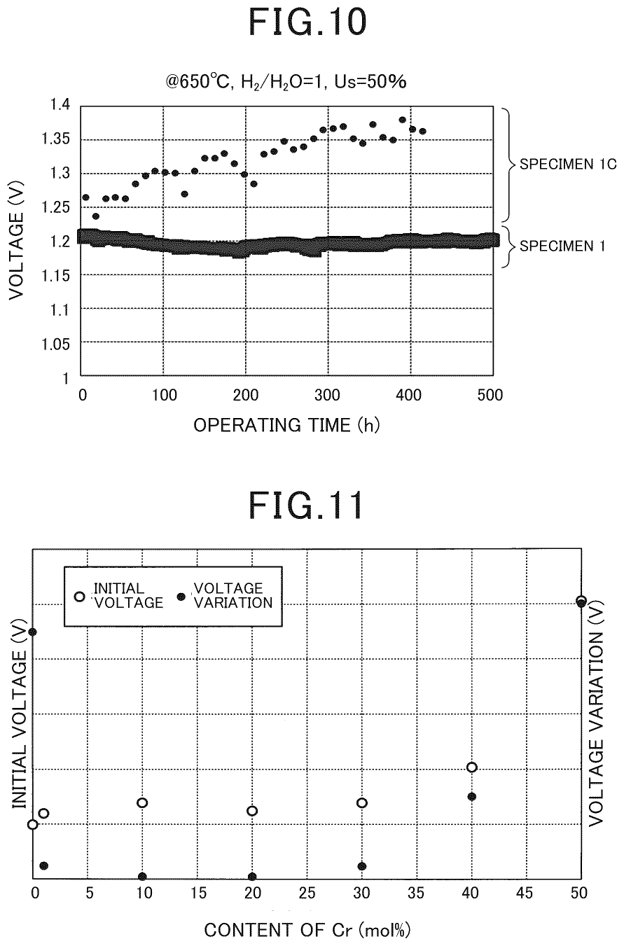

The durability test was performed as follows. First, the electrochemical cells of Specimen 1 and Specimen 1C functioned as SOECs. The temperature was increased to 650° C. while N₂ (500 ml) was introduced into the fuel electrode layer and the air electrode layer. Water vapor and H₂ were then introduced into the fuel electrode layer (H₂/H₂O=1 by volume), and atmospheric air was introduced into the air electrode layer. Under these conditions, an electrolytic test (operating temperature: 650° C.) was performed. In the present experimental example, a water vapor utilization rate is equal to 50% (Us=50%). The test results are shown in FIG. 10.

FIG. 10 shows the test results. FIG. 10 shows a relationship between operating time (h) for the durability test and voltage (V) in the electrochemical cells of Specimen 1 and Specimen 1C obtained in the present experimental example. In FIG. 10, a horizontal axis shows the operating time for the durability test, and a vertical axis shows the voltage. As shown in FIG. 10, Specimen 1C, in which the solid electrolyte particle contains the zirconia-based oxide and does not contain Cr, even though the catalyst material particle contained Ni and Cr, showed a gradual increase in cell resistance and voltage as the operating time for the durability test increased. This is because the fuel electrode layer of Specimen 1C could not suppress the wetting and spreading (decrease in surface tension) of Ni in the high-temperature reducing atmosphere during cell operation with the applied voltage; thus, the degradation of the fuel electrode layer due to the migration of Ni could not be suppressed.

In contrast, Specimen 1, in which the catalyst material particle contains Ni and Cr and the solid electrolyte particle contains the ceria-based oxide and Cr, satisfies the requirements of the present disclosure. Therefore, in Specimen 1, the cell resistance remains stable, and the voltage does not increase even after a long period of operation during the durability test. This is because the fuel electrode layer of Specimen 1 could suppress the wetting and spreading of Ni in the high-temperature reducing atmosphere during cell operation with the applied voltage; thus, the degradation of the fuel electrode layer due to the migration of Ni was suppressed.

### Experimental Example 2

In the present experimental example, several specimens were prepared as follows. In the same process as the electrochemical cell of Specimen 1 in Experimental Example 1, a plurality of electrochemical cells (Specimens 2 to 7) was prepared with different contents of Cr (mol % in terms of oxide) in the fuel electrode layer. Here, the content of Cr was adjusted by changing the amount of Cr(NO₃)₃ mixed with the NiO powder, and the electrochemical cells from Specimen 2 to Specimen 7 were obtained. The content of Cr in each fuel electrode layer of Specimens 2 to 7 was 1 mol % (Specimen 2), 10 mol % (Specimen 3), 20 mol % (Specimen 4), 30 mol % (Specimen 5), 40 mol % (Specimen 6), and 50 mol % (Specimen 7) in terms of oxide.

Specimen 2C was also prepared as a comparison specimen. The difference between the preparation of the electrochemical cell of Specimen 1 and that of Specimen 2C is that Cr(NO₃)₃ was not added when the paste for forming the fuel electrode layer was prepared, and NiO slurry, which does not contain Cr, was used as the catalyst material slurry. The electrochemical cell of Specimen 2C was prepared by the same process as that of Specimen 1, except for the above point.

Electrolytic tests were performed using each electrochemical cell of the specimens under the same conditions as the durability test in Experimental Example 1. An initial voltage (V) and voltage (V) after 100 hours of operation (i.e., after durability) were measured. A voltage variation (V) was calculated by a formula (voltage variation=voltage after durability-initial voltage). The test results are shown in FIG. 11.

FIG. 11 shows a relationship between the content of Cr (mol %) and the initial voltage (V) and a relationship between the content of Cr (mol %) and the voltage variation (V) in each electrochemical cell of Specimens 2 to 7 and Specimen 2C obtained in the present experimental example. In FIG. 11, a horizontal axis shows the content of Cr, and a vertical axis shows the initial voltage or the voltage variation. As shown in FIG. 11, it can be seen that the voltage remains stable after durability testing when the content of Cr is within a range of 1 mol % or more and 30 mol % or less. On the other hand, when the content of Cr exceeds 30 mol %, the voltage after durability increases, and the durability tends to deteriorate. Additionally, from the viewpoint of the initial voltage, it can be seen that reducing the content of Cr to 30 mol % or less can ensure the suppression of output decrease due to voltage increase. From the above analysis results, it was confirmed that the content of Cr of 1 mol % or more and 30 mol % or less can effectively suppress the degradation of the fuel electrode layer due to the migration of Ni, while maintaining the function of the electrochemical cell to generate and output hydrogen.

### Experimental Example 3

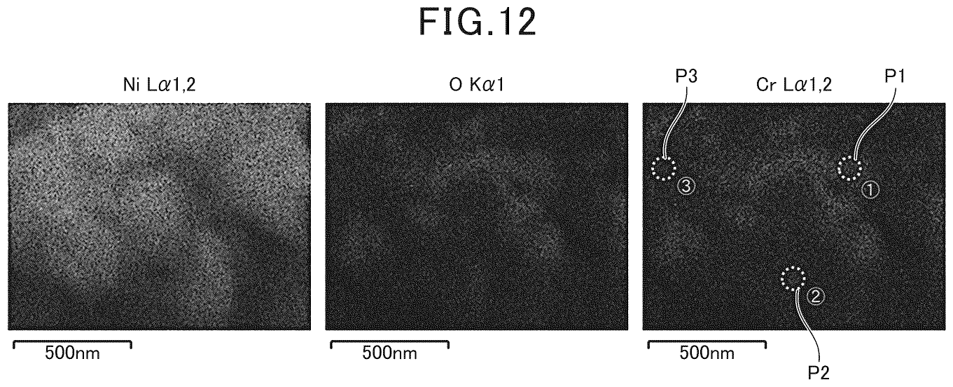

In the present experimental example, for the fuel electrode layer of the electrochemical cell of Specimen 1, the cross-section of the catalyst material particle was subjected to a surface process with ion milling, and the mapping images of the Ni element, the O element, and the Cr element were acquired for the same location by the SEM-EDX analysis. The analysis results are shown in FIG. 12.

FIG. 12 shows the SEM-EDX analysis results of the fuel electrode layer in the electrochemical cell of Specimen 1 obtained in the present experimental example (however, measurement regions are different from those in FIG. 8). As shown in FIG. 12, a comparison of the mapping images for each element shows that O (oxygen) is distributed in each region Ni and Cr. This confirms that Cr used as the metal M in the present experimental example is present as an oxide rather than that of Ni, and that a structure can be formed to realize effects provided by the technology of the present disclosure (e.g., the electrochemical cell of Specimen 1).

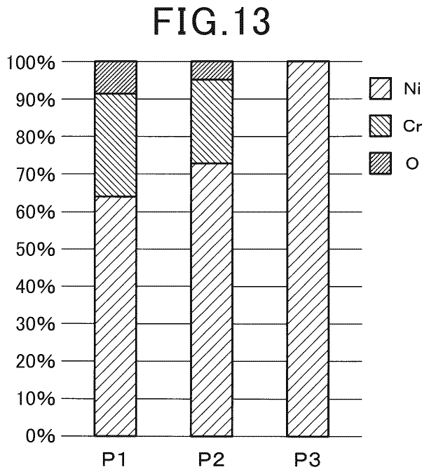

Next, in the mapping image of the Cr element, we arbitrarily selected regions rich in Cr (concentration regions: regions P1 and P2 in FIG. 12) and a region where Ni was primarily contained and not rich in Cr (non-concentration region: region P3 in FIG. 12). The mass fraction of the O element in the selected regions P1 to P3 was then measured. The mass fractions of the Ni and Cr elements in the selected regions P1 to P3 were also measured. The measurement results are shown in FIG. 13.

FIG. 13 shows the mass fractions of the Ni element, the Cr element, and the O element in the regions P1, P2, and P3, where Cr is concentrated and Ni is mainly present, obtained in the present experimental example. As shown in FIG. 13, a comparison of the mass fraction of the O element in the region P3, where Ni is primarily contained, and the regions P1 and P2, where Cr is concentrated, shows that the relationship of (mass fraction of the O element in the region P3)<(mass fraction of the O element in the region P1) and (mass fraction of the O element in the region P3)<(mass fraction of the O element in the region P2) is satisfied. Therefore, this result shows that the ratio of Cr contained in the fuel electrode layer as an oxide is greater than that of Ni contained in the fuel electrode layer 1. Additionally, from the results of the above-mentioned experimental examples, it was confirmed that in a case of an electrochemical cell (fuel electrode layer) having such a configuration, it is easy to exhibit the mechanism for suppressing the degradation of the fuel electrode layer due to the migration of Ni, and the improvement of the durability of the fuel electrode layer can be ensured.

The present disclosure is not limited to the above embodiments and the above experimental examples. Various modifications can be made to the technology of the present disclosure as long as they do not deviate from the gist thereof. The elements shown in the above embodiments and the above experimental examples can be arbitrarily combined with each other.

The structures regarding the technology of the present disclosure are shown below.

### (Structure 1)

A fuel electrode layer for use in a solid oxide-type electrochemical cell, including
catalyst material particles, solid electrolyte particles, and at least one metal M selected from a group consisting of metals having a standard electrode potential more negative than that of Ni, in which
the catalyst material particle includes Ni as its primary component, and further includes the metal M, and
the solid electrolyte particle includes a ceria-based oxide as its primary component, and further includes the metal M.

### (Structure 2)

The fuel electrode layer according to Structure 1, in which
the metal M is at least one selected from a group consisting of Cr, V, and Mn.

### (Structure 3)

The fuel electrode layer according to Structure 1 or 2, in which
a concentration of the metal M in the solid electrolyte particles is higher than a concentration of the metal M in the catalyst material particles.

### (Structure 4)

The fuel electrode layer according to any one of Structures 1 to 3, in which
a content of the metal M relative to Ni contained in the fuel electrode layer is within a range of 1 mol % or more and 30 mol % or less in terms of oxide.

### (Structure 5)

The fuel electrode layer according to any one of Structures 1 to 4, in which
a ratio of the metal M contained in the fuel electrode layer as an oxide is greater than that of Ni contained in the fuel electrode layer as the oxide.

### (Structure 6)

A solid oxide-type electrochemical cell including
the fuel electrode layer according to any one of Structures 1 to 5, a solid electrolyte layer, and an air electrode layer, which is formed as a counter electrode to the fuel electrode layer, in this order, in which
the solid electrolyte layer has an electrolyte body layer in contact with the fuel electrode layer, and
the electrolyte body layer includes a ceria-based oxide as its primary component, and further includes at least one metal M selected from a group consisting of metals having a standard electrode potential more negative than that of Ni.

What is claimed is:

1. A fuel electrode layer for use in a solid oxide-type electrochemical cell, comprising
catalyst material particles, solid electrolyte particles, and at least one metal M selected from a group consisting of metals having a standard electrode potential more negative than that of Ni, wherein
the catalyst material particle includes Ni as its primary component, and further includes the metal M, and
the solid electrolyte particle includes a ceria-based oxide as its primary component, and further includes the metal M.

2. The fuel electrode layer according to claim 1, wherein
the metal M is at least one selected from a group consisting of Cr, V, and Mn.

3. The fuel electrode layer according to claim 1, wherein
a concentration of the metal M in the solid electrolyte particles is higher than a concentration of the metal M in the catalyst material particles.

4. The fuel electrode layer according to claim 1, wherein
a content of the metal M relative to Ni contained in the fuel electrode layer is within a range of 1 mol % or more and 30 mol % or less in terms of oxide.

5. The fuel electrode layer according to claim 1, wherein
a ratio of the metal M contained in the fuel electrode layer as an oxide is greater than that of Ni contained in the fuel electrode layer as the oxide.

6. A solid oxide-type electrochemical cell comprising
the fuel electrode layer according to claim 1, a solid electrolyte layer, and an air electrode layer, which is formed as a counter electrode to the fuel electrode layer, in this order, wherein
the solid electrolyte layer has an electrolyte body layer in contact with the fuel electrode layer, and
the electrolyte body layer includes a ceria-based oxide as its primary component, and further includes at least one metal M selected from a group consisting of metals having a standard electrode potential more negative than that of Ni.
